(19) United States
(12) Patent Application Publication
(10) Pub. No.: US 2007/0227065 A1
(43) Pub. Date: Oct. 4, 2007

(54) Transport mechanism for use in a manufactured seed assembly

(75) Inventors: Paul G Gaddis, Seattle, WA (US); Michael Teodoro, Tacoma, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/687,787

(22) Filed: Mar. 19, 2007

Related U.S. Application Data
(60) Provisional application No. 60/787,317, filed on Mar. 30, 2006.

(51) Int. Cl. A01C 1/00

(52) U.S. Cl. 47/58.1 SE

(57) ABSTRACT

A transport mechanism (20) for use in a manufactured seed assembly is provided. The transport mechanism includes first and second arms (24a and 24b) attached to an actuator (22). Each of the first and second arms having an attachment end (46) coupled to the actuator and a free end (48). The first and second arms being deployable between a closed position, wherein the first and second arms are displaced towards each other for clamping onto an object (34) having a shape, and an open position. The transport mechanism also includes a gripping member (50) located on the free end of each of the first and second arms.

### CROSS REFERENCE TO RELATED APPLICATION

The present application claims the benefit of U.S. Provisional Application No. 60/787,317, filed Mar. 30, 2006.

### BACKGROUND

Asexual propagation for plants has been shown for some species to yield large numbers of genetically identical embryos, each having the capacity to develop into a normal plant. Such embryos must usually be further cultured under laboratory conditions until they reach an autotrophic “seedling” state characterized by an ability to produce their own food via photosynthesis, resist desiccation, produce roots able to penetrate soil, and fend off soil microorganisms. Some researchers have experimented with the production of artificial seeds, known as manufactured seeds, in which individual plant somatic or zygotic embryos are encapsulated in a seed coat. Examples of such manufactured seeds are disclosed in U.S. Pat. No. 5,701,699, issued to Carlson et al., the disclosure of which is hereby expressly incorporated by reference.

Typical manufactured seeds include a seed shell, synthetic gametophyte and a plant embryo. A manufactured seed that does not include the plant embryo is known in the art as a “seed blank.” The seed blank typically is a cylindrical capsule having a closed end and an open end. The synthetic gametophyte is placed within the seed shell to substantially fill the interior of the seed shell. A longitudinally extending hard porous insert, commonly known as a cotyledon restraint, may be centrally located within the synthetic gametophyte and includes a centrally located cavity extending partially through the length of the cotyledon restraint. The cavity is sized to receive the plant embryo therein. The well-known plant embryo includes a radicte end and a cotyledon end. The plant embryo is deposited within the cavity of the cotyledon restraint cotyledon end first and is sealed within the seed blank by at least one end seal. There is a weakened spot in the end seal to allow the radicle end of the embryo to penetrate the end seal.

Currently, there are automated processes available to mass produce manufactured seeds of the type described above. One such automated process is described in U.S. patent application Ser. No. 10/982,951, entitled System and Method of Embryo Delivery for Manufactured Seeds, and assigned to Weyerhaeuser Company of Federal Way, Wash., the disclosure of which is hereby expressly incorporated by reference. Such automated processes include a tweezer-like apparatus having prongs to retrieve cotyledon restraints for insertion into the seed blank. Typically, the prongs are manufactured from a high strength material, such as steel or aluminum.

Although such tweezer-like apparatuses are effective, they are not without their problems. As a non-limiting example, because the prongs are manufactured from a high strength material, they are very stiff and not pliable. Thus, there exists a need for a clamping mechanism to handle and manipulate cotyledon restraints for producing manufactured seeds.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A transport mechanism for use in a manufactured seed assembly is provided. The transport mechanism includes first and second arms attached to an actuator. Each of the first and second arms includes an attachment end coupled to the actuator and a free end. The first and second arms are deployable between a closed position, wherein the first and second arms are displaced towards each other for clamping onto an object having a shape, and an open position.

The transport mechanism also includes a gripping member located on the free end of each of the first and second arms. The gripping members substantially conform to the shape of a predetermined portion of the object when the object is located between the first and second arms and the first and second arms are in the closed position.

### DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric view of a transport mechanism constructed in accordance with one embodiment of the present disclosure;

FIG. 2 is a cross-sectional side planar view of a manufactured seed produced in part by the transport mechanism of FIG. 1;

FIG. 3 is an exploded view of an attachment arm of the transport mechanism; and

FIG. 4 is a partial side cross-sectional view the transport mechanism shown in a closed position and applying a clamping load to an object.

### DETAILED DESCRIPTION

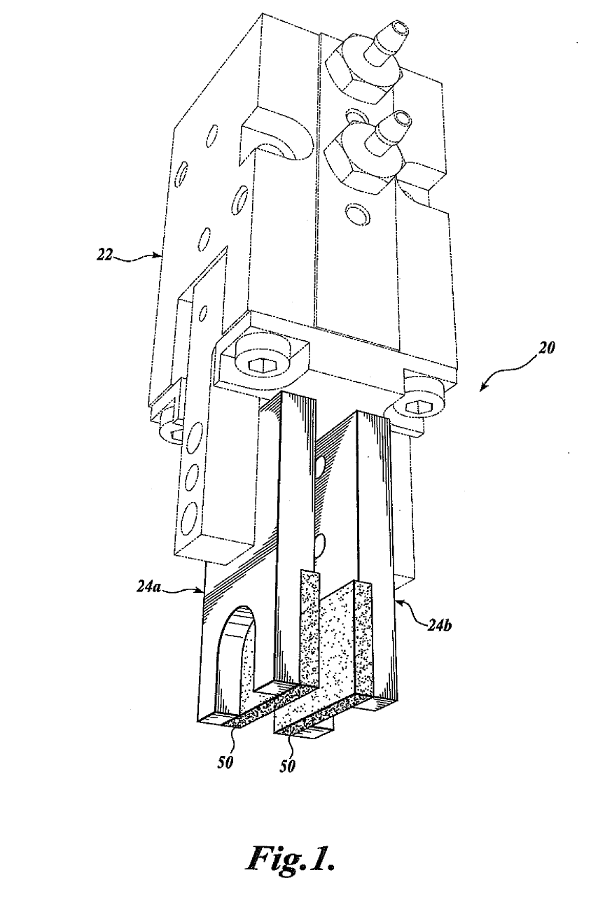

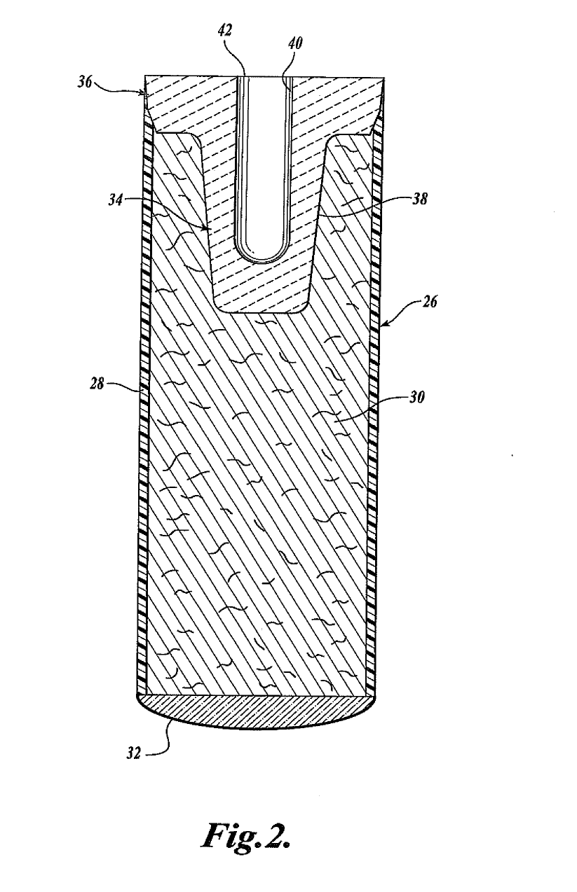

FIG. 1 illustrates a transport mechanism 20 constructed in accordance with one embodiment of the present disclosure. The transport mechanism 20 includes a well-known actuator 22 (shown in phantom), such as a pneumatic air cylinder, Model No. 19060-2-0001 manufactured and sold by PHD, Inc of 9009 Clubridge Drive, Fort Wayne, Ind. 46809. The transport mechanism 20 also includes first and second attachment arms 24a and 24b. The transport mechanism 20 is intended to be used in an automated assembly for mass producing manufactured seeds 26 of the type illustrated in FIG. 2.

The manufactured seed 26 includes a seed shell 28, a nutritive media 30, such as a gametophyte, a dead end seal 32 and a combination live end seal and cotyledon restraint (“cylcap 34). The seed shell 28 is suitably formed from a section of tubular material. In one embodiment, the seed shell 28 is a sectioned straw of fibrous material, such as paper. The sections of straw may be pre-treated in a suitable coating material, such as wax. In other embodiments, the seed shell 28 is formed from a section of biodegradable, plastic material.

The cylcap 34 is suitably manufactured from a porous material having a hardness strong enough to resist puncture or fracture by a germinating embryo, such as a ceramic material, and includes an end seal portion 36 and a cotyledon restraint portion 38. The cotyledon restraint portion 38 is suitably integrally or unitarily formed with the end seal portion 36. The cylcap 34 also includes a longitudinally extending cavity 40 extending through the end seal portion 36 and partially through one end of cotyledon restraint portion 38. The open end of the cavity 40 is known as a cotyledon restraint opening 42. The cavity 40 is sized to receive a plant embryo (not shown) therein.

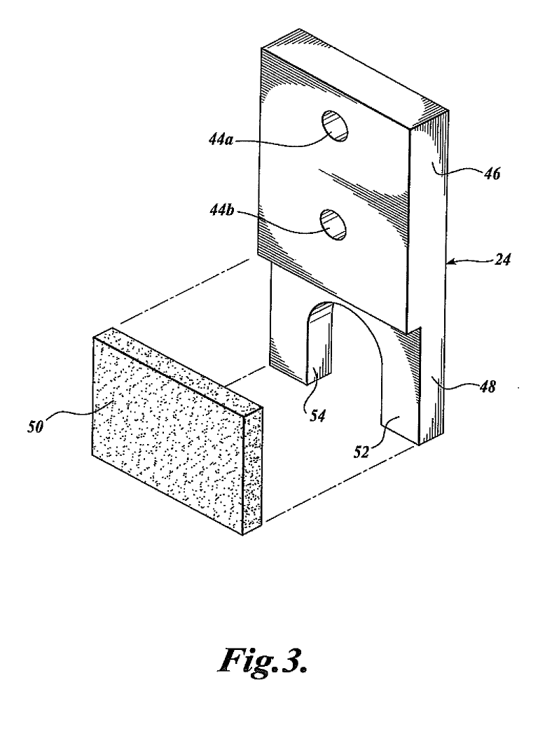

The attachment arms 24 may be best understood by referring to FIG. 3. As the first and second attachment arms 24a and 24b are identically configured, only one attachment arm is described in greater detail. Accordingly, it should be apparent that the description of one attachment arm applies to both. The attachment arm 24 is suitably formed from a high strength material, such as aluminum, and is attachable to the actuator 22 by well-known fasteners (not shown) extending through corresponding bores 44a and 44b.

The bores 44a and 44b are located at an attachment end 46 of the attachment arm 24. The free end 48 of the attachment arm 24 includes means for deforming, such as a gripping member 50. Other types of structures capable of carrying out the function of deforming include a flexible attachment arm that is capable of deforming to the necessary extent and substantially geometrically conform to the shape of the cylcap 34. The gripping member 50 is suitable a pad of compressible material, such as foam. It is sized to be secured within a cut away portion 52 formed in the free end 48 of the attachment arm 24. The gripping member 50 is secured within the cut away portion 50 by well-known methods, such a glue. Although it is preferred that the free end 48 includes a cut away portion 52, it is not so required. Accordingly, other embodiments, such attachment arms without a cut away portion 52, are also within the scope of the present disclosure.

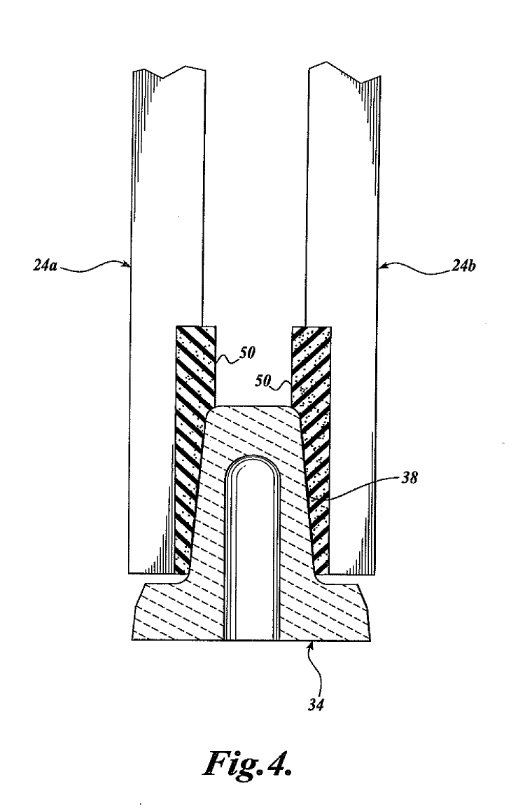

Still referring to FIG. 3, the free end 48 includes a cavity 54. The cavity 54 is suitably positioned behind the gripping member 50 to accommodate deflections of the gripping member 50 associated with clamping onto a cylcap 34, as described in greater detail with reference to FIG. 4. Attachment arms constructed without the cavity 54 are also contemplated within the scope of the present disclosure.

Operation of the transport mechanism 20 may be best understood by referring to FIG. 4. During the assembly of a manufacture seed 26, a cylcap 34 is retrieved from a remote location by the transport mechanism 20. Specifically, the first and second attachment arms 24a and 24b are actuated into a closed position, where the first and second arms 24a and 24b clamp onto a predetermined portion of the cylcap 34. As a non-limiting example, the first and second attachment arms 24a and 24b clamp onto the cotyledon restraint portion 38 of the cylcap 34. As the first and second attachment arms 24a and 24b clamp onto the cylcap 34, the gripping members 50 substantially conform in shape to the corresponding shape of the cotyledon restraint portion 38.

The term “substantially” does not require (and does not exclude) that the gripping members 50 completely conform to the geometry of the cylcap 34. Instead, it is intended to include deformations that are similar to the shape of an object disposed between the first and second attachment arms 24a and 24b.

When the first and second attachment arms 24a and 24b are in the closed position and the arms 24a and 24b include the cavity 54, a portion of the gripping members 50 may be deflected into the cavity 54. Specifically, as the first and second arms 24a and 24b are displaced into the closed position, the gripping members 50 deflect into the cavity 54 due to the clamping pressure associated with the first and second attachment aims 24a and 24b clamping onto the cylcap 34. As such, the cavity 54 permits the use of a thinner gripping member 50.

While illustrative embodiments have been illustrated and described, it will be appreciated that various changes can be made therein without departing from the spirit and scope of the invention.

1. A transport mechanism for use in a manufactured seed assembly, the transport mechanism comprising:
(a) first and second arms attached to an actuator, each of the first and second arms having an attachment end coupled to the actuator and a free end, the first and second arms being deployable between a closed position, wherein the first and second arms are displaced towards each other for clamping onto an object having a shape, and an open position; and
(b) a gripping member located on the free end of each of the first and second arms, the gripping members substantially conforming to the shape of a predetermined portion of the object when the object is located between the first and second arms and the first and second arms are in the closed position.

2. The transport mechanism of claim 1, wherein the gripping members are formed from a compressible material.

3. The transport mechanism of claim 1, wherein the free ends of each of the first and second arms includes a cavity sized to receive one of the gripping members.

4. The transport mechanism of claim 3, wherein the cavities extend through a thickness of the first and second arms to permit deformation of the gripping members into the respective cavity when the first and second arms are in the closed position and the object is disposed therebetween.

5. A transport mechanism for use in a manufactured seed assembly, the transport mechanism comprising:
(a) first and second arms attached to an actuator, each of the first and second arms having an attachment end coupled to the actuator and a free end, the first and second arms being deployable between a closed position, wherein the first and second arms are displaced towards each other for applying a clamping pressure on an object having a shape, and an open position; and
(b) means for deforming, the means for deforming located on the free end of each of the first and second arms and substantially conforming to the shape of a predetermined portion of the object when the object is located between the first and second arms and the first and second arms are in the closed position.

6. The transport mechanism of claim 5, wherein the means for deforming comprising a pad of deformable material.

7. The transport mechanism of claim 6, wherein the free end of each of the first and second arms includes a cavity to permit deformation of the pad of deformable material into respective cavity when the first and second arms are in the closed position and the object is disposed therebetween.
